(19) United States
(12) Patent Application Publication
(10) Pub. No.: US 2011/0125507 A1
(43) Pub. Date: May 26, 2011

(54) Method and System for Frequency Domain Postfiltering of Encoded Audio Data in a Decoder

(75) Inventor: Rongshan Yu, Singapore (SG)

(73) Assignee: Dolby Laboratories Licensing Corporation, San Francisco, CA (US)

(21) Appl. No.: 13/054,518

(22) PCT Filed: Jul. 14, 2009
(86) PCT No.: PCT/US2009/050501

§ 371 Date: Jan. 17, 2011

Related U.S. Application Data
(60) Provisional application No. 61/081,800, filed on Jul. 18, 2008.

(51) Int. Cl. G10L 19/00; G10L 19/04

(52) U.S. Cl. 704/500

(57) ABSTRACT

A decoder configured to generate decoded audio data (e.g., decoded speech data) and including a postfilter coupled and configured to filter encoded audio data in the frequency domain, methods for frequency domain postfiltering of encoded audio data in a decoder, and methods for decoding encoded audio data in a decoder including by postfiltering encoded audio data in the frequency domain in the decoder. In some embodiments, the decoder is configured to decode input encoded audio without performing any time-to-frequency domain transform on encoded audio data to prepare data for postfiltering. Typically, the postfiltering improves the quality of the decoded audio signal by attenuating spectral valley regions thereof to remove excess quantization noise present in the encoded input audio while preserving formants of the decoded audio signal to avoid introducing unnecessary distortion.

### CROSS-REFERENCE TO RELATED APPLICATIONS

This application claims benefit of priority of U.S. Provisional Application No. 61/081,800, filed 18 Jul. 2008, hereby incorporated by reference.

### BACKGROUND OF THE INVENTION

1. Field of the Invention

The present invention relates to methods and systems for decoding of encoded audio data (e.g., linear predictive encoded (LPC) speech data or other encoded speech data or other audio data).

2. Background of the Invention

Throughout this disclosure including in the claims, the expression “encoded data” (or “coded data”) denotes data that has been generated by encoding other data (referred to as “input data”), and on which at least one decoding step must be performed to recover the input data (or a noisy version of the input data) therefrom. For example, data that has been generated by encoding input data and then undergone at least one decoding step is “encoded data” if at least one additional decoding step must be performed thereon to recover the input data therefrom.

Throughout this disclosure including in the claims, the term “postfilter” denotes a filter configured to filter audio data, so as to reduce or eliminate audible noise in the audio data, or (in the case that the postfilter is employed to filter encoded audio data) to reduce or eliminate audible noise in a decoded version of the encoded audio data.

Digital audio compression systems have been extensively used in modem telecommunication system or home/personal audiovisual entertainment systems to reduce the data rates of digital audio signals. Most of these systems rely on either predictive or transform audio coding techniques to reduce redundancy of the audio signal, thereby generating a compact representation of the signal with minimal loss in perceptual quality. In a predictive audio coder, a time-domain LPC (linear predictive coding) filter is applied to decorrelate the input signal and the white residual signal output from the LPC filter is further compressed, usually by using a vector quantizer. In a transform audio coder, the input signal is first converted from the time domain to the frequency domain using a transform (e.g., the MDCT or FFT), and the resulting frequency domain data values are then quantized and coded.

It has been found that predictive coding provides better coding efficiency for pure speech signals compared with transform coding since the LPC filter/residual model used in predictive coding closely resembles the mechanism of the human articulation system. On the other hand, it has also been found that transform coding schemes often outperform predictive coding schemes for encoding many audio signals (e.g., music or other audio signals that are not pure speech signals) including many sinusoidal components which can be represented more compactly in the transform domain (the frequency domain).

The transform predictive coding paradigm combines the merits of the two aforementioned coding architectures to provide a tool that can effectively code speech, generic audio and mixtures (e.g., mixed speech and music signals) in a simple unified framework. Examples of transform predictive coding methods and systems are described in Juin-Hwey Chen and D. Wang, “Transform Predictive Coding of Wideband Speech Signals,” Proc. ICASSP 1996, pp. 275-278.

FIG. 1 is a block diagram of a conventional transform predictive coder. In the transform predictive speech/audio coder of FIG. 1, the input audio signal is sampled, and the samples (time-domain digital audio samples) are asserted to an LPC analysis filter. The LPC analysis filter removes the input signal's coarse formant structure (the formants of a speech signal are the signal's frequency components at the resonant frequencies of the speaker's vocal tract) to generate an LPC residual signal, and also generates a set of LPC parameters. The LPC residual signal is then transformed into the frequency domain (in the stage labeled “Transform” in FIG. 1) to further exploit any signal correlation remaining in the LPC residual signal. Then, the transformed LPC residual signal (consisting of frequency-domain data values) is quantized and coded (in the stage labeled “Quantizer” in FIG. 1) to achieve data rate reduction. The LPC parameters used in the LPC analysis filter are then multiplexed with the quantized, transformed LPC residual (in the stage labeled “Bitstream Demux” in FIG. 1) to produce a compressed audio bit-stream. A suitable conventional decoder can use the LPC parameters of the compressed audio bit-stream to reconstruct the formant structure of the decoded audio signal.

The compressed audio bit-stream output from the coder (the quantized, transformed LPC residual multiplexed with a sequence of sets of LPC parameters) is sent to the decoder. The decoder of a transform predictive speech/audio coder performs the reverse signal processing of the encoder. FIG. 2 is a block diagram of a conventional decoder for decoding the output of the transform predictive coder of FIG. 1. The first stage (labeled “Bitstream Demux”) of FIG. 2 demultiplexes the LPC parameters used in the LPC analysis filter and the quantized, transformed LPC residual. The quantized, transformed LPC residual is dequantized (in the stage labeled “Dequantizer” in FIG. 2), and the dequantized, transformed LPC residual (consisting of frequency domain audio data) is inverse-transformed back into the time domain (in the stage labeled “Inverse Transform” in FIG. 2) to generate a recovered LPC residual (indicative of the LPC residual originally generated in the LPC Analysis Filter of the FIG. 1 coder). An LPC Synthesis filter processes the recovered LPC residual with the recovered LPC parameters (in the time domain) to generate recovered time-domain digital audio samples indicative of the audio signal originally input to the FIG. 1 coder.

One of the challenges of an audio coding system, whether it is based on transform coding or predictive coding, is to control audible noise that is typically introduced when the original input signal is quantized and coded. In modern audio coding schemes some sort of perceptual coding technology is typically employed to control such coding noise so that the noise is masked by other prominent events in the original signal. Unfortunately, such techniques are effective only when the audio coder is working at bit rates above a certain limit. When the audio coder is working lower than that limit, the coding noise can become audible (after the noisy encoded data are decoded). In this case certain trade-offs have to be made so that only essential parts of the audio signal are represented with good fidelity. With low-data rate speech coders, it is common practice to sacrifice the spectral valley regions of speech and preserve the formants (the frequency components of the speech in regions near to, and including, the formant frequencies) since the latter are perceptually more important in speech perception.

Recognizing that excess quantization noise can be introduced during coding of speech samples to generate encoded speech data (for subsequent decoding in a decoder), it has been proposed to suppress the excess quantization noise in the decoder using an adaptive postfilter that attenuates both the speech signal and the noise in the spectral valleys of the decoded speech signal. Examples of such noise suppression using an adaptive postfilter are described in J.-H. Chen and A. Gersho, “Adaptive Postfilter for Quality Enhancement of Coded Speech,” IEEE Transactions on Speech and Audio Processing, vol. 3, no. 1, January 1995.

It has been proposed to suppress excess quantization noise using an adaptive postfilter in a transform predictive speech/audio decoder. FIG. 3 is a block diagram of a conventional transform predictive speech/audio decoder that includes such a postfilter. The first four stages of the FIG. 3 decoder are identical to the identically labeled stages of the FIG. 2 system. In the FIG. 3 decoder, the postfilter stage receives and operates (in the time-domain) on the decompressed (decoded), recovered samples of time-domain audio data generated in the LPC Synthesis Filter, in order to further suppress excess coding noise in the spectral valley regions of the recovered audio signal if any such noise is present. In the FIG. 3 decoder, the LPC parameters used conventionally in the LPC Synthesis Filter are also used in the postfilter to construct the postfilter properly according the spectral envelope of the decoded signal. It is known to implement a postfilter (in a decoder of the type shown in FIG. 3) to implement two filtering functions (e.g., each in a different stage of the postfilter): a short-term postfilter that suppresses excess coding noise in the spectral valley regions of the recovered audio signal to a greater extent than in frequency regions near to and including the formant frequencies of the recovered audio signal; and a long-term adaptive postfilter that attenuates quantization noise between pitch harmonics.

It has been proposed to implement adaptive postfiltering in the frequency domain for enhancing noisy audio data. For example, Wang, et al., “Frequency Domain Adaptive Postfiltering for Enhancement of Noisy Speech,” Speech Communication, Vol. 12, pp. 41-56, 1993, describes such postfiltering using an LPC analysis filter and a DFT (discrete Fourier transform) stage, each coupled and configured to receive input audio data. The DFT stage performs a discrete Fourier transform on the input audio to generate frequency domain audio data. The output of the LPC analysis filter is employed to determine the postfilter, and the postfilter is applied (in the frequency domain) to a modified version of the frequency domain audio data. However, Wang et al. do not explain or suggest implementing a postfilter in a decoder to operate in the frequency domain on encoded audio data in the decoder (e.g., encoded audio data generated in a transform predictive coder or other audio data coder) or how to implement such a postfilter.

U.S. Pat. No. 6,941,263, issued on Sep. 6, 2005, describes a postfilter for filtering (in the frequency domain) decoded (synthesized) speech data in a decoder. The decoder performs LPC synthesis on encoded speech data (that have undergone encoding in an LPC analysis filter in a predictive coder) to generate a synthesized speech signal (comprising time-domain samples of speech data), then performs a time-to-frequency domain transform on the synthesized speech signal to generate frequency domain data indicative of the synthesized speech signal, then performs postfiltering in the frequency domain on the frequency domain data, and then performs a frequency-to-time domain transform on the postfiltered data to generate a postfiltered, synthesized speech signal. It would be desirable to implement postfiltering in the frequency domain in a decoder without performing any time-to-frequency domain transform in the decoder to prepare data for the postfiltering, to implement postfiltering on encoded data in a decoder, and to implement postfiltering in the frequency domain on encoded data in a decoder in a manner producing output audio of better perceived quality than attainable with conventional frequency domain postfiltering.

### BRIEF DESCRIPTION OF THE INVENTION

In a class of embodiments, the invention is a decoder configured to generate decoded audio data (e.g., decoded speech data) by decoding encoded audio data (e.g., encoded speech data). The decoder includes a postfilter (e.g., a frequency domain adaptive postfilter) coupled and configured to filter encoded audio data (e.g., encoded input audio data that have been generated in an encoder and asserted as input to the decoder, or a partially decoded version of such encoded input audio data) in the frequency domain. The decoder is configured to decode input encoded audio data without performing any time-to-frequency domain transform on encoded audio data (e.g., the encoded input audio data or a partially decoded version thereof) to prepare data for filtering in the postfilter.

In another class of embodiments, the invention is a decoder configured to generate decoded audio data (e.g., decoded speech data) by decoding encoded audio data (e.g., encoded speech data) that have been generated in a transform predictive coder (e.g., a transform predictive speech/audio coder). The decoder includes a postfilter (e.g., a frequency domain adaptive postfilter) coupled and configured to filter encoded audio data (e.g., encoded input audio data that have been generated in the transform predictive coder, or a partially decoded version of such encoded input audio data) in the native frequency domain of the transform predictive coder.

In typical embodiments in either class, the postfiltering performed by the postfilter improves the quality of the decoded audio signal by attenuating spectral valley regions thereof to remove excess quantization noise present in the encoded input audio (when excess quantization noise is present in the encoded input audio), while preserving formants of the decoded audio signal to avoid introducing unnecessary distortion. In typical embodiments, the postfilter is particularly useful when the encoded input audio data are indicative of speech or a speech-like audio signal, and have been generated in an audio coder working at a low data rate. In typical embodiments, the postfilter is also useful and advantageous when the encoded input audio data are indicative of a mixed audio signal containing both speech and music.

The postfilter of the inventive decoder can be implemented in hardware, firmware, or software. In typical embodiments, the inventive decoder is or includes a programmable digital signal processor or general or special purpose computer system, and the postfilter is implemented in software or firmware executed by the digital signal processor or computer system. In other embodiments, the inventive decoder is or includes a digital signal processor (e.g., a pipelined digital signal processor), and the postfilter is implemented in hardware in the digital signal processor.

In some preferred embodiments, a postfilter of the inventive decoder is coupled and configured to receive LPC residual data and to filter the LPC residual data in the frequency domain. In some cases, the decoder includes a dequantizer (e.g., a subsystem including a dequantizer) and the LPC residual data are generated in the dequantizer and indicative of a dequantized, transformed LPC residual. In other cases, the decoder includes a combined dequantizer and postfilter, and the LPC residual data are indicative of a quantized, transformed LPC residual. The combined dequantizer and postfilter receives and operates in the frequency domain on the LPC residual data to generate a postfiltered and dequantized LPC residual.

In some preferred embodiments, a postfilter of the inventive decoder has the transfer function G·H(e^{j\acute{ω}}), where ω is the frequency (e.g., w is the frequency of an audio signal segment including a data value to be postfiltered, or each data value to be postfiltered is a frequency component having frequency ω) and where:

$$H ( z ) = ( 1 - μ {z}^{- 1} ) \frac{1 - P ( z / β )}{1 - P ( z / α )} , z = {e}^{j {ω}^{′}} ,$$

α, β and μ are parameters that satisfy 0</β<α<1, and 0<μ<1,

P(z)=Σᵢ₌₁^{M}αᵢz⁻ⁱ is the audio signal segment's LPC predictor, where αᵢ, i=1, . . . , M are the LPC coefficients and M is the LPC prediction order, and

G is a gain filter (a function of e^{j\acute{ω}}).

In typical embodiments, the gain filter G is:

G(e^{j\acute{ω}})=G=[1/∫₀^{π}|H(e^{jω})|²dω]^{1/2}.

In some preferred embodiments in which the postfilter of the inventive decoder has the transfer function G·H(e^{j\acute{ω}}), and the postfilter multiplies each data value (associated with the frequency ω) of a dequantized, transformed LPC residual signal by the value G·H(e^{j\acute{ω}}). Thus, the postfiltered value of each data value (associated with the frequency ω) is simply given by: P(\acute{ω})=|G·H(e^{j\acute{ω}})|. After such postfiltering, the postfiltered LPC residual signal is inverse transformed (into the time domain).

Other aspects of the invention are methods for postfiltering encoded audio data in the frequency domain in any embodiment of the inventive decoder. Other aspects of the invention are methods for decoding encoded audio data (e.g., encoded speech data) in any embodiment of the inventive decoder, each said decoding method including a step of postfiltering encoded audio data in the frequency domain in the decoder.

### BRIEF DESCRIPTION OF THE DRAWINGS

FIG. 1 is a block diagram of a conventional transform predictive coder.

FIG. 2 is a block diagram of a conventional decoder for decoding the output of the coder of FIG. 1.

FIG. 3 is a block diagram of another conventional decoder for decoding the output of the FIG. 1 coder, including a postfilter (e.g., an adaptive postfilter) which operates (in the time domain) on decompressed (decoded), recovered samples of time-domain audio data generated in an LPC Synthesis Filter.

FIG. 4 is a block diagram of an embodiment of the inventive decoder, configured for decoding the output of a coder of the type shown in FIG. 1.

FIG. 5 is a block diagram of another embodiment of the inventive decoder, configured for decoding the output of a coder of the type shown in FIG. 1.

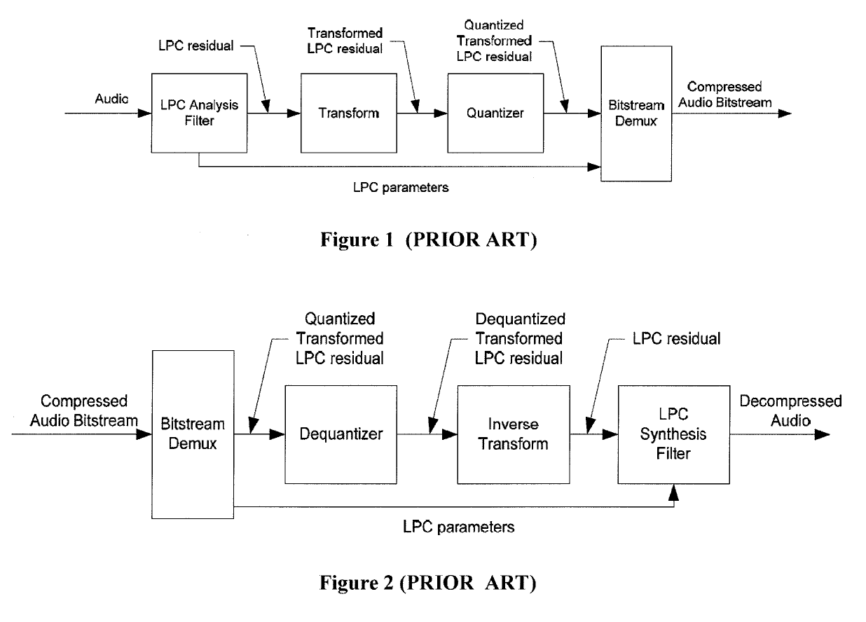

### DETAILED DESCRIPTION OF THE PREFERRED EMBODIMENTS

Many embodiments of the present invention are technologically possible. It will be apparent to those of ordinary skill in the art from the present disclosure how to implement them.

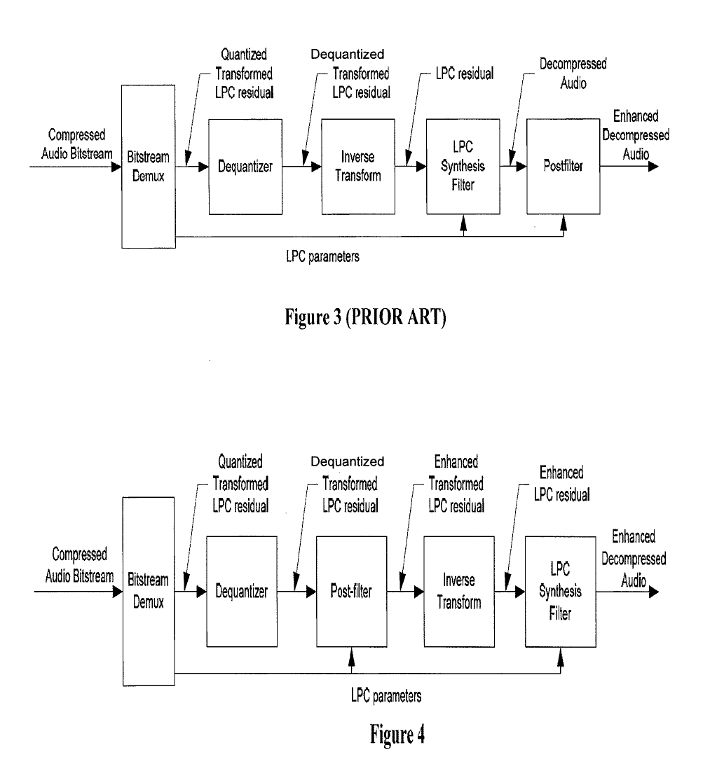

A first embodiment of the inventive decoder will be described with reference to FIG. 4. The first two stages of the FIG. 4 decoder can be identical to the identically labeled stages of the conventional decoder of FIG. 3, and the fourth and fifth states of the FIG. 4 decoder can be identical respectively to the identically labeled third and fourth stages of the FIG. 3 decoder. In the FIG. 4 decoder, the postfilter (the decoder's third stage) receives and operates in the frequency-domain on the dequantized, transformed LPC residual generated in the second (Dequantizer) stage to generate a postfiltered (“enhanced”) transformed LPC residual. The enhanced transformed LPC residual (consisting of frequency domain audio data) is inverse-transformed into the time domain in the fourth stage (labeled “Inverse Transform” in FIG. 4) to generate an enhanced LPC residual.

The postfilter of FIG. 4 uses the recovered LPC parameters (demultiplexed from the quantized, transformed LPC residual in the decoder's first stage and asserted to the postfilter) to determine adaptively the current postfilter parameters for generating the enhanced LPC residual. The LPC Synthesis filter (the decoder's fifth stage) processes the enhanced LPC residual in the time domain with the recovered LPC parameters to generate recovered time-domain digital audio samples indicative of the audio signal originally input to the coder.

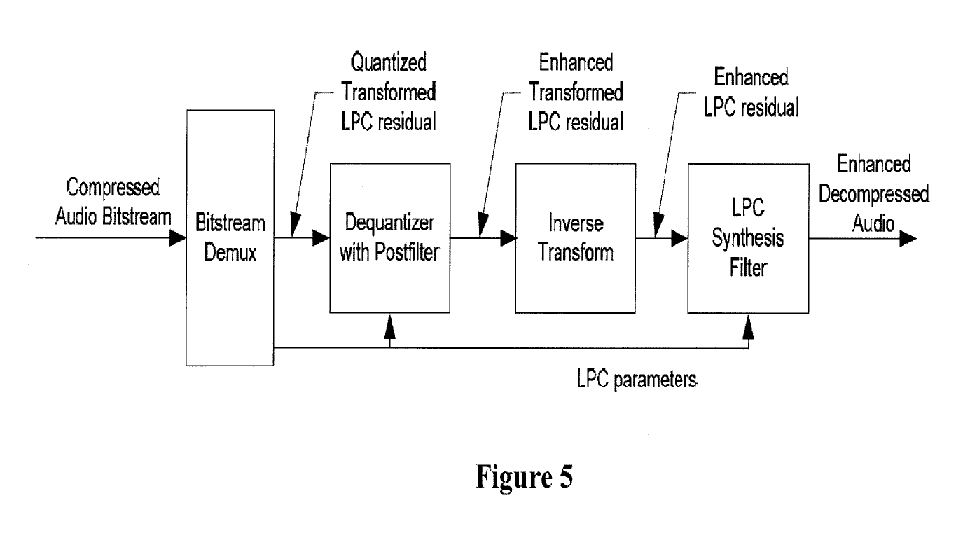

A second embodiment of the inventive decoder will be described with reference to FIG. 5. The first stage of the FIG. 5 decoder can be identical to the identically labeled stage of the conventional decoder of FIG. 3, and the third and fourth states of the FIG. 5 decoder can be identical respectively to the identically labeled third and fourth stages of the FIG. 3 decoder. In the FIG. 5 decoder, a combined dequantizer and postfilter (the decoder's second stage) receives and operates in the frequency-domain on quantized, transformed LPC residual that has been separated (demultiplexed) from the LPC parameters in the decoder's first stage to generate a postfiltered and dequantized (“enhanced”) transformed LPC residual. The enhanced transformed LPC residual (consisting of frequency domain audio data) is inverse-transformed into the time domain in the third stage (labeled “Inverse Transform” in FIG. 5) to generate an enhanced LPC residual.

The postfilter of FIG. 5 uses the recovered LPC parameters (demultiplexed from the quantized, transformed LPC residual in the decoder's first stage and asserted to the postfilter) to determine adaptively the current postfilter parameters for generating the enhanced LPC residual. The LPC Synthesis filter (the decoder's fourth stage) processes the enhanced LPC residual in the time domain with the recovered LPC parameters to generate recovered time-domain digital audio samples indicative of the audio signal originally input to the coder.

The decoder of each of FIGS. 4 and 5 is configured to decode input encoded audio data without performing any time-to-frequency domain transform on encoded audio data (e.g., the encoded input audio data or a partially decoded version of the encoded input audio data) to prepare data for postfiltering in the postfilter. Also, the decoder of each of FIGS. 4 and 5 is configured to generate decoded audio data (e.g., decoded speech data) by decoding encoded audio data (e.g., encoded speech data) that have been generated in a predictive transform speech/audio coder, and the decoder's postfilter is coupled and configured to filter encoded input audio data that have been generated in the transform predictive coder (or a partially decoded version of such encoded input audio data) in the native frequency domain of the transform predictive coder.

The frequency domain postfilter of the inventive decoder (e.g., the postfilter of FIG. 4 and that of FIG. 5) preferably provides flat and unitary response in the formants of the decoded audio signal (the formants are the frequency components of the decoded signal in regions near to, and including, the formant frequencies) and preferably attenuates only the spectral valley regions of the decoded signal. The postfilter is preferably adaptive over time in order to adapt to the changing characteristics of the audio signal.

For any given segment of the audio signal to be decoded, the postfilter can be implemented to have the desired response in a manner to be described below. The description will refer to the following pole-zero filter:

$$H ( z ) = ( 1 - μ {z}^{- 1} ) \frac{1 - P ( z / β )}{1 - P ( z / α )} , 0 < β < α < 1 , 0 < μ < 1.$$

In this pole-zero filter, P(z)ᵢ₌₁^{M}αᵢz⁻¹ is the LPC predictor of the relevant audio signal segment where αᵢ, i=1, . . . , M are the LPC coefficients and M is the LPC prediction order. In a transform predictive decoder, the LPC coefficients αᵢ are readily available from the compressed bit stream (the encoded audio bit stream asserted as input to the decoder). The parameters α, β and μ control the overall tilt (overall or averaged slope of the audio signal's frequency-amplitude spectrum) and the level of attenuation of the postfilter and play important role in determining the quality of the postfilter. It was found that the following parameters give satisfactory results in typical implementations of the postfilter of FIG. 4 (and the postfilter of FIG. 5):

α=0.8, β=0.5, and μ=0.5.

To avoid change the overall loudness of the decoded output the gain of the postfilter is preferably further normalized. This is done by multiplying the frequency domain filter H by a gain filter (sometimes referred to herein as a gain correctness factor) G. In typical embodiments, the value of G (for the relevant audio signal segment at frequency location ω) is:

G=[1/∫₀^{π}|H(e^{jω})|²dω]^{1/2}.

We next describe two methods for implementing the frequency domain postfilter in embodiments of the invention in which the inventive decoder is a transform predictive speech/audio decoder:

1. In the first method (to be referred to sometimes herein as the “explicit” method), the postfilter G·H(e^{j\acute{ω}}), where ω is the frequency associated with each data value to be postfiltered and the symbol “·” denotes simple multiplication, is implemented as follows. Each data value (associated with the frequency ω) of the dequantized, transformed LPC residual signal from the dequantizer is multiplied by the value G·H(e^{j\acute{ω}}), before the postfiltered LPC residual signal is inverse transformed. Thus, the postfiltered value of each data value (associated with the frequency ω) is simply given by: P(\acute{ω})=|G·H(e^{j\acute{ω}})|. Typically, there is one data value (to be postfiltered) for each frequency, ω, but in some embodiments each data value in a set of two or more data values (all to be postfiltered) is associated with a single frequency, ω (e.g., the center frequency of the frequencies associated with the set of data values). The postfilter of FIG. 4 can be implemented in accordance with the explicit method.

2. In the second method (to be referred to sometimes herein as the “implicit” method) postfiltering in the frequency domain of each data value associated with a frequency ω (e.g., by the postfilter G·H(ω), where the symbol “·” denotes simple multiplication) is combined with an operation of dequantizing each such data value (also in the frequency domain). The combined postfiltering and dequantization operation is implemented in accordance with the design of the dequantizer actually used. For example, if a lattice dequantizer is used, the reconstruct points of the dequantizer are preferably made as a function of the amplitude response of the postfilter (preferably the postfilter G·H(ω)), so that the outputs of smaller variances are produced at frequency locations where the amplitude response of the postfilter is smaller. The postfilter of FIG. 5 can be implemented in accordance with the implicit method.

While specific embodiments of the present invention and applications of the invention have been described herein, it will be apparent to those of ordinary skill in the art that many variations on the embodiments and applications described herein are possible without departing from the scope of the invention described and claimed herein. It should be understood that while certain forms of the invention have been shown and described, the invention is not to be limited to the specific embodiments described and shown or the specific methods described.

What is claimed is:

1. A decoder configured to generate decoded audio data in response to input audio indicative of encoded input audio data, said decoder including:
a postfilter coupled and configured to filter encoded audio data in the frequency domain, wherein the decoder is configured to decode the encoded input audio data without performing any time-to-frequency domain transform on encoded audio data to prepare data for filtering in the postfilter.

2. The decoder of claim 1, wherein the postfilter is a frequency domain adaptive postfilter.

3. The decoder of claim 1, also including:
a first subsystem coupled to receive the input audio and configured to generate partially decoded audio data in response to the input audio, and wherein the postfilter is coupled and configured to filter the partially decoded audio data in the frequency domain.

4. The decoder of claim 1, wherein the input audio is indicative of the encoded input audio data and quantization noise, the decoded audio data are indicative of a decoded audio signal, and the postfilter is configured to filter the encoded audio data so as to improve quality of the decoded audio signal by attenuating spectral valley regions thereof to remove at least some of the quantization noise while preserving formants of the decoded audio signal.

5. The decoder of claim 1, wherein the encoded input audio data include LPC residual data, and the postfilter is coupled and configured to receive the LPC residual data and to filter the LPC residual data in the frequency domain.

6. The decoder of claim 1, wherein the encoded input audio data include quantized LPC residual data, and wherein said decoder also includes a subsystem including a dequantizer, the subsystem is configured to generate dequantized LPC residual data in response to the input audio, and the postfilter is coupled to the subsystem and configured to receive the dequantized LPC residual data and to filter said dequantized LPC residual data in the frequency domain.

7. The decoder of claim 1, wherein the encoded input audio data include quantized LPC residual data, and the decoder also includes:
a first subsystem configured to extract the quantized LPC residual data from the input audio,
and wherein the postfilter is a combined dequantizing and postfiltering subsystem of the decoder, coupled and configured to generate dequantized, postfiltered LPC residual data in response to the quantized LPC residual data including by filtering said quantized LPC residual data in the frequency domain.

8. The decoder of claim 1, wherein the postfilter has a transfer function G·H(e^{j\acute{ω}}), where ω is the frequency, and where:
$$H ( z ) = ( 1 - μ {z}^{- 1} ) \frac{1 - P ( z / β )}{1 - P ( z / α )} , z = {e}^{j {ω}^{′}} ,$$
α, β and μ are parameters that satisfy 0<β<α<1, and 0<μ<1,
P(z)=Σᵢ₌₁^{M}αᵢz⁻¹ is the audio signal segment's LPC predictor, where αᵢ, i=1, . . . , M are LPC coefficients and M is a LPC prediction order, and
G is a gain filter.

9. The decoder of claim 8, wherein the gain filter G is:
G(e^{j\acute{ω}})=G=[1/∫₀^{π}|H(e^{jω})|dω]^{1/2}.

10. The decoder of claim 8, also including a subsystem configured to generate a dequantized, transformed LPC residual in response to the input audio, and wherein the postfilter is coupled to the subsystem and configured to multiply each data value associated with the frequency ω of the dequantized, transformed LPC residual by the value |G·H(e^{j\acute{ω}})|.

11. A decoder configured to generate decoded audio data in response to input audio indicative of encoded input audio data generated in a transform predictive coder having a native frequency domain, said decoder including:
a postfilter coupled and configured to filter encoded audio data in the native frequency domain of the transform predictive coder.

12. The decoder of claim 11, wherein the postfilter is a frequency domain adaptive postfilter.

13. The decoder of claim 11, also including:
a first subsystem coupled to receive the input audio and configured to generate partially decoded audio data in response to the input audio, and wherein the postfilter is coupled and configured to filter the partially decoded audio data in the native frequency domain of the transform predictive coder.

14. The decoder of claim 11, wherein the input audio is indicative of the encoded input audio data and quantization noise, the decoded audio data are indicative of a decoded audio signal, and the postfilter is configured to filter the encoded audio data so as to improve quality of the decoded audio signal by attenuating spectral valley regions thereof to remove at least some of the quantization noise while preserving formants of the decoded audio signal.

15. The decoder of claim 11, wherein the encoded input audio data include LPC residual data, and the postfilter is coupled and configured to receive the LPC residual data and to filter the LPC residual data in the frequency domain.

16. The decoder of claim 11, wherein the encoded input audio data include quantized LPC residual data, and wherein said decoder also includes a subsystem including a dequantizer, the subsystem is configured to generate dequantized LPC residual data in response to the input audio, and the postfilter is coupled to the subsystem and configured to receive the dequantized LPC residual data and to filter said dequantized LPC residual data in the frequency domain.

17. The decoder of claim 11, wherein the encoded input audio data include quantized LPC residual data, and the decoder also includes:
a first subsystem configured to extract the quantized LPC residual data from the input audio,
and wherein the postfilter is a combined dequantizing and postfiltering subsystem of the decoder, coupled and configured to generate dequantized, postfiltered LPC residual data in response to the quantized LPC residual data including by filtering said quantized LPC residual data in the frequency domain.

18. The decoder of claim 11, wherein the postfilter has a transfer function G·H(e^{j\acute{ω}}), where ω is the frequency, and where:
$$H ( z ) = ( 1 - μ {z}^{- 1} ) \frac{1 - P ( z / β )}{1 - P ( z / α )} , z = {e}^{j {ω}^{′}} ,$$
α, β and μ are parameters that satisfy 0<β<α<1, and 0<μ<1,
P(z)=Σᵢ₌₁^{M}αᵢz⁻ⁱ is the audio signal segment's LPC predictor, where αᵢ, i=1, . . . , M are LPC coefficients and M is a LPC prediction order, and
G is a gain filter.

19. The decoder of claim 18, wherein the gain filter G is:
G(e^{j\acute{ω}})=G=[1/∫₀^{π}|H(e^{jω})²dω]^{1/2}.

20. The decoder of claim 18, also including a subsystem configured to generate a dequantized, transformed LPC residual in response to the input audio, and wherein the postfilter is coupled to the subsystem and configured to multiply each data value associated with the frequency ω of the dequantized, transformed LPC residual by the value |G·H(e^{j\acute{ω}})|.
